(19) United States
(12) Patent Application Publication
(10) Pub. No.: US 2025/0258979 A1
(43) Pub. Date: Aug. 14, 2025

(54) WAKE-INTERACTION NETWORK ANALYSIS MODEL FOR WIND FARM OPTIMIZATION

(71) Applicant: NEC Laboratories America, Inc., Princeton, NJ (US)

(72) Inventors: Yangmin DING, East Brunswick, NJ (US); Ting WANG, West Windsor, NJ (US)

(73) Assignee: NEC Laboratories America, Inc., Princeton, NJ (US)

(21) Appl. No.: 19/050,665

(22) Filed: Feb. 11, 2025

Related U.S. Application Data
(60) Provisional application No. 63/552,750, filed on Feb. 13, 2024.

(51) Int. Cl. G06F 30/27; G06F 113/06; G06F 119/06

(52) U.S. Cl. CPC G06F 30/27; G06F 2113/06; G06F 2119/06

(57) ABSTRACT

Disclosed is a wake-interaction network analysis model for wind farm optimization and method to manage and mitigate complex wake interactions in wind farms. Operationally, our method creates a dynamic network model where each wind turbine is treated as a node within a comprehensive network. The interactions between these nodes, representing the wake effects of one turbine on another, are mapped as weighted edges in the network. These weights are quantified based on sophisticated wake models, incorporating factors like wind speed, direction, and atmospheric conditions. Furthermore, our inventive method and model exhibits a dynamic adaptability to changing wind conditions. Unlike traditional static models, it recalculates the network's edges in real-time, reflecting the varying impact of wake interactions as wind direction and speed fluctuate. This dynamic adaption advantageously ensures that the model remains accurate and relevant under different environmental scenarios.

### CROSS-REFERENCE TO RELATED APPLICATIONS

This application claims the benefit of U.S. Provisional Patent Application Ser. No. 63/552,750 filed Feb. 13, 2024, the entire contents of which is incorporated by reference as if set forth at length herein.

### FIELD OF THE INVENTION

This application relates generally to electrical energy generation. More particularly, it pertains to electrical energy generation from wind farms and a method of optimizing wind farm electrical energy generation using a wake-interaction network analysis model.

### BACKGROUND OF THE INVENTION

As those skilled in the art will readily understand and appreciate, windfarms-a group of wind turbines in the same geographic location used to generate electricity-are a valuable source of renewable electrical energy that can help reduce reliance on fossil fuels and mitigate climate change.

Wind farm turbines harness the kinetic energy of the wind and convert it into electrical energy. Wind farms can be located onshore or offshore, and they vary in size from a few turbines to hundreds of turbines spread across a large area.

Wind farms are important for several reasons.

Clean and renewable energy source: Wind turbines harness the power of the wind to generate electricity, which is a clean and renewable source of energy. This means that it doesn't produce greenhouse gases or other pollutants that contribute to climate change.

Reduces reliance on fossil fuels: By generating electricity from wind, reliance on fossil fuels is reduced, which are a major source of pollution and contribute to climate change.

Cost-effective: Wind power is becoming increasingly cost-competitive with other forms of energy. In many areas, it is now cheaper to generate electricity from wind than from fossil fuels.

Create jobs: The wind energy industry is a growing sector that is creating jobs in manufacturing, installation, maintenance, and other areas.

Boosts local economies: Wind farms can bring economic benefits to rural communities in the form of jobs, land lease payments, and increased tax revenue.

Energy independence: By generating our own electricity from wind, we can reduce our dependence on foreign sources of energy.

Overall, wind farms are an important part of the transition to a cleaner and more sustainable energy future

In a wind farm, each turbine generates a wake-a region of reduced wind speed behind it. This wake can significantly impact the performance of downstream turbines, reducing their energy output. The problem becomes complex when considering a wind farm with multiple turbines, where wakes from different turbines interact and overlap, creating a dynamic and intricate pattern of wind speed variations across the wind farm

### SUMMARY OF THE INVENTION

An advance in the art is made according to aspects of the present disclosure directed to a wake-interaction network analysis model for wind farm optimization provides a novel method to manage and mitigating the complex wake interactions in wind farms.

Providing this sharp advance in the art, our inventive method utilizes principles of network theory combined with advanced mathematical modeling and addresses the difficult challenge of maximizing energy output while minimizing the adverse effects of wake interactions among turbines.

Viewed from a first aspect, our inventive method creates a dynamic network model where each wind turbine is treated as a node within a comprehensive network. The interactions between these nodes, representing the wake effects of one turbine on another, are mapped as weighted edges in the network. These weights are quantified based on sophisticated wake models, incorporating factors like wind speed, direction, and atmospheric conditions.

Advantageously, our inventive method and model exhibits a dynamic adaptability to changing wind conditions. Unlike traditional static models, it recalculates the network's edges in real-time, reflecting the varying impact of wake interactions as wind direction and speed fluctuate. This dynamic adaption advantageously ensures that the model remains accurate and relevant under different environmental scenarios.

Additionally, our proposed model employs advanced optimization algorithms to determine the most efficient layout of turbines, aiming to maximize the total energy output of the wind farm. It also suggests operational strategies, such as adjusting turbine yaw angles or rotor speeds, to mitigate wake effects dynamically.

Furthermore, our inventive method and model surpasses existing wake effect models by providing a more holistic and adaptable approach. More particularly, our method and model integrates complex data and provides actionable insights for both design and operation of wind farms which advantageously marks a significant leap forward in renewable energy technology, paving the way for more efficient and sustainable wind power generation

### BRIEF DESCRIPTION OF THE DRAWING

FIG. 1 is a schematic diagram showing illustrative wake effect in a wind farm of electrical energy generating turbines.

FIG. 2 is a schematic flow diagram showing an illustrative wake-interaction network analysis model for wind farms according to aspects of the present disclosure.

FIG. 3 is a schematic diagram showing illustrative architecture features and relationships or sequences of operation of systems and methods according to aspects of the present disclosure.

FIG. 4 is a schematic diagram showing an illustrative computer system on which methods according to aspects of the present disclosure may be executed.

### DETAILED DESCRIPTION OF THE INVENTION

The following merely illustrates the principles of this disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are intended to be only for pedagogical purposes to aid the reader in understanding the principles of the disclosure and the concepts contributed by the inventor(s) to furthering the art and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that any block diagrams herein represent conceptual views of illustrative circuitry embodying the principles of the disclosure.

Unless otherwise explicitly specified herein, the FIGs comprising the drawing are not drawn to scale.

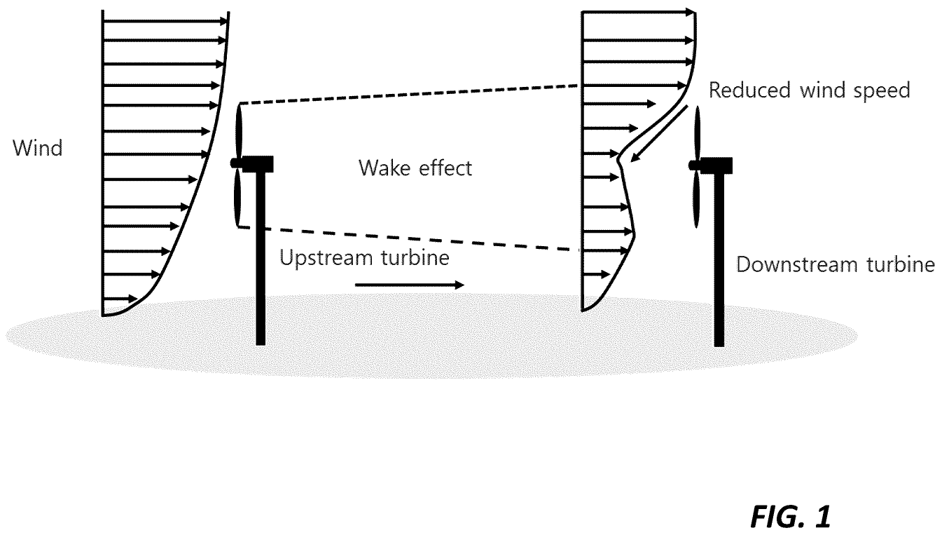

By way of some additional background, we again note that in a wind farm, each turbine generates a wake-a region of reduced wind speed behind it. This wake can significantly impact the performance of downstream turbines, reducing their energy output, as depicted in FIG. 1, which is a schematic diagram showing illustrative wake effect in a wind farm of electrical energy generating turbines.

Those skilled in the art will understand and appreciate that the wake effect problem becomes complex when considering a wind farm with multiple turbines, where wakes from different turbines interact and overlap, creating a dynamic and intricate pattern of wind speed variations across the farm.

Accordingly, our inventive method and model according to the present disclosure addresses include:
Maximizing Total Energy Output: Designing the wind farm layout and operational strategy to maximize the total energy output, considering the wake effects;
Dynamic Wake Interaction: Accounting for the dynamic nature of wake effects, which vary with changing wind speed and direction;
Optimal Turbine Placement: Determining the optimal placement of turbines to minimize the negative impacts of wake effects on each other; and
Operational Efficiency: Developing operational strategies (like adjusting yaw angles or rotor speeds) to mitigate wake effects in real-time.

As we shall show and describe, our inventive method and model introduces a novel approach to managing and mitigating the complex wake interactions in wind farms, utilizing principles of network theory combined with advanced mathematical modeling. It addresses the pressing challenge of maximizing energy output while minimizing the adverse effects of wake interactions among turbines.

At the core of our inventive method is the creation of a dynamic network model where each wind turbine is treated as a node within a comprehensive network. The interactions between these nodes, representing the wake effects of one turbine on another, are mapped as weighted edges in the network. These weights are quantified based on sophisticated wake models, incorporating factors like wind speed, direction, and atmospheric conditions.

One of the key aspects of our inventive method and model is its dynamic adaptability to changing wind conditions. Unlike traditional static models, it recalculates the network's edges in real-time, reflecting the varying impact of wake interactions as wind direction and speed fluctuate. This inventive aspect ensures that the model remains accurate and relevant under different environmental scenarios.

Additionally, our inventive model employs advanced optimization algorithms to determine the most efficient layout of turbines, aiming to maximize the total energy output of the wind farm. It suggests operational strategies, such as adjusting turbine yaw angles or rotor speeds, to mitigate wake effects dynamically.

As will become apparent to those skilled in the art, our inventive model surpasses existing wake effect models by offering a more holistic and adaptable approach. Its ability to integrate complex data and provide actionable insights for both the design and operation of wind farms marks a significant leap forward in renewable energy technology, paving the way for more efficient and sustainable wind power generation.

As we shall show and describe, our inventive method and model provides a number of innovative features, each contributing significantly to solving the problem of optimizing wind farm efficiency by managing and mitigating wake effects. These inventive features, systematically structured in the model, will address key challenges in wind farm operation and energy production. These inventive features include:

### Network Construction with Turbine Nodes and Wake Interaction Edges

The representation of each turbine as a node and the wake interactions as directed edges between these nodes is a foundational feature. It allows for a clear and structured visualization of the complex dynamics within a wind farm, enabling more precise calculations and analyses of wake effects.

### Weight Assignment Using Wake Models (Jensen Model)

Assigning weights to the edges based on wake effect models, particularly using the Jensen model, provides a quantitative measure of the wake's impact from one turbine on another. This inventive approach allows for a more nuanced understanding and calculation of wake effects, which is crucial for optimizing turbine placement and operation.

### Wake Influence Mapping with Directional Influence and Atmospheric Adjustments

The introduction of directional influence calculations and adjustments based on atmospheric conditions like humidity, temperature, and stability in our proposed model, adds a layer of sophistication. This feature significantly enhances the model's accuracy by accounting for real-world variabilities that affect wake behavior.

### Dynamic Adaptation to Changing Wind Conditions

The ability of the model to dynamically adapt to changing wind conditions, including wind speed and direction, ensures that the model's output remains relevant and accurate in real time. This feature is crucial for responding promptly to environmental changes, a key challenge in wind farm management.

### Optimization of Turbine Placement and Operational Strategies

The model's use in optimizing turbine placement and developing operational strategies addresses the core problem of maximizing energy output while minimizing wake losses. By iteratively testing various layouts and operational parameters, the model helps identify the most efficient configuration.

### Advanced Control Strategy Using Machine Learning

Incorporating machine learning for predictive control and real-time adjustments introduces an innovative aspect to the model. It leverages historical and current data to predict optimal settings, enhancing the model's adaptability and responsiveness to changing conditions.

### Real-Time Visualization and Monitoring

The development of a real-time visualization dashboard that displays wake interactions, performance metrics, and operational status of each turbine is an inventive feature. It not only aids in immediate decision-making but also enhances the understanding of wake dynamics for operators and managers.

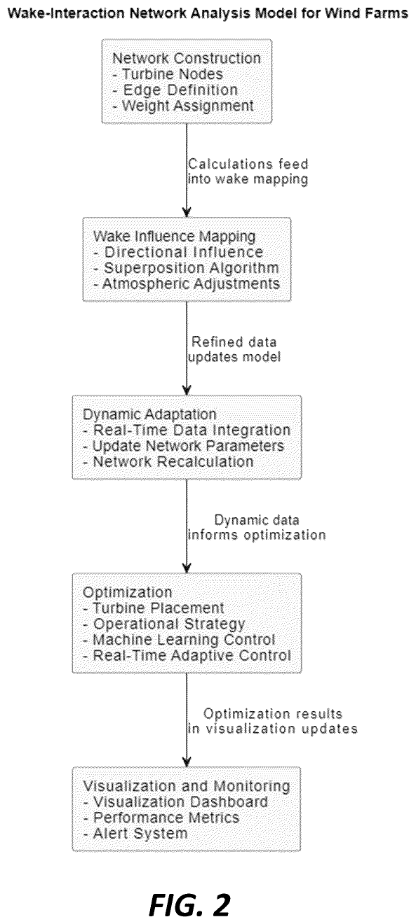

FIG. 2 is a schematic flow diagram showing an illustrative wake-interaction network analysis model for wind farms according to aspects of the present disclosure.

### Step 1: Network Construction

This step creates a detailed representation of the wind farm as a network where nodes represent turbines, and edges represent wake interactions.

### Node Definition

Turbine Nodes (Tᵢ)—Represent each turbine in the wind farm as a node Tᵢ, where i is the index of the turbine.

### Edge Definition

A directed edge from turbine node Tᵢ to turbine node Tⱼ represents the wake effect of turbine i on turbine j.

These edges are determined based on the relative positioning of turbines and prevailing wind directions.

### Weight Assignment

Wake Effect Models for Weight Calculation—Assign weights to edges based on wake effect models like the Jensen model. The weight wᵢⱼ on the edge from Tᵢ to Tⱼ represents the impact of turbine i′s wake on turbine j, calculated using the velocity deficit.

Using the Jensen Model for Weight Assignment—The weight can be calculated using the Jensen model equation for velocity deficit:

$${w}_{i j} = {V}_{∞} ( 1 - \sqrt{1 - {C}_{T , i}} ) {( \frac{{D}_{i}}{{D}_{i} + 2 α {x}_{i j}} )}^{2}$$

Where V_{∞} is the free-stream wind speed, C_{T,i} is the thrust coefficient, Dᵢ is the diameter of the ith turbine rotor, α is the wake decay constant, and xᵢⱼ is the distance from turbine i to turbine j.

### Step 2: Wake Influence Mapping

In this step, we aim to accurately map how each turbine's wake affects other turbines within the wind farm. This step involves calculating the influence of wakes on downstream turbines, considering factors like wind direction, intensity, and spread.

### Directional Influence and Wake Adjustment

Incorporate Wind Direction—Adjust the wake effect calculations to account for the variability in wind direction. The impact of a wake on a downstream turbine changes based on the relative alignment of the turbines to the wind direction. In this step, we develop a function f(θ) that scales the wake effect based on the relative angle between the wind direction and the turbine alignment.

$$f ( θ ) = {cos}^{2} ( θ - {θ}_{t u r b i n e} )$$

Where ϑ is the wind direction, and θ_{turbine} is the orientation of the turbine axis. The cosine squared term ensures that the wake effect is strongest when the wind direction aligns with the turbine axis and decreases as the angle increases.

### Novel Superposition Algorithm for Overlapping Wakes

Model Overlapping Wakes—When wakes from multiple upstream turbines overlap and affect a single downstream turbine, model this combined effect. Instead of linearly adding the wake effects, we propose a probabilistic approach to account for the stochastic nature of wake overlap.

$${V}_{def , combined} = 1 - {\prod }_{k} ( 1 - {V}_{def , k} )$$

Where V_{def,k} represents the normalized velocity deficit from each overlapping wake. Our novel approach considers the probability of wake effects combining nonlinearly, providing a more realistic combined wake effect.

### Atmospheric Condition Adjustments

Account for Atmospheric Variability—Modify the wake effect calculation to include factors like atmospheric stability, humidity, and temperature, which can influence wake behavior.

$$g ( Atmospheric Conditions ) = 1 + β \cdot Atmospheric Factor$$

Where g (Atmospheric Conditions) adjusts the velocity deficit based on current atmospheric conditions. β is a scaling factor determined empirically (such as regression analysis) or through machine learning algorithms (such as neural network), and Atmospheric Factor is a composite measure derived from atmospheric stability, humidity, and temperature. This function amplifies or reduces the wake effect based on the atmospheric conditions.

### Step 3: Dynamic Adaptation to Changing Wind Conditions

While Step 2 we establish the framework for how wake effects are influenced by wind direction and atmospheric conditions, in Step 3 we focus on the real-time adaptation and recalibration of the network model in response to ongoing changes in these conditions.

### Real-Time Data Integration

Data Sources—Use real-time meteorological data from within the wind farm (e.g., anemometers) and regional weather services.

### Dynamic Update of Network Parameters

Adaptation to Wind Speed and Direction—Continuously update the model with current wind speed (V_{∞}) and direction (ϑ).

### Network Recalculation Algorithm

Algorithm for Updating Edge Weights-Update the weights of all edges in the network based on the new wind conditions.
For each edge (Tᵢ→Tⱼ) in the network:

$${w}_{i j , n e w} = {V}_{∞ , n e w} ( 1 - \sqrt{1 - {C}_{T , i}} ) {( \frac{{D}_{i}}{{D}_{i} + 2 α {x}_{i j}} )}^{2} \cdot f ( {θ}_{n e w} )$$

Where V_{∞,new} and ϑ_{new} are the updated wind speed and direction. f(ϑ_{new}) is the function accounting for directional influence, recalculated with the new wind direction.

### Step 4: Optimization of Turbine Placement and Operational Strategies

In this step, we utilize the dynamic wake interaction network model to optimize turbine placement within the wind farm and develop effective operational strategies that maximize overall energy production while minimizing negative wake effects.

### Turbine Placement Optimization

Optimization Goal—Arrange turbines in a configuration that minimizes wake interference and maximizes overall energy output.

Optimization Algorithm—Implement an algorithm that iterates over various turbine layouts, evaluating the total energy output based on the dynamic wake interaction model.

$${max}_{layout} {\sum }_{i = 1}^{N} E ( {T}_{i} )$$

Where E (Tᵢ) is the expected energy output of turbine Tᵢ based on its wake interactions, and N is the total number of turbines.

### Operational Strategy Development

Advanced Control Strategy Using Machine Learning—Develop strategies such as adjusting yaw angles, blade pitch, or rotational speed to mitigate the impact of wakes on downstream turbines.

Control Algorithm for Real-Time Adjustment—Implement a machine learning algorithm that predicts optimal turbine settings (yaw, pitch, speed) based on real-time wake interaction data, atmospheric conditions, and expected power output. This could involve training a model (like a neural network) on historical data and then applying it to make real-time adjustments.:
Settings T_{i,new}=ML Model (W_{ij,new},Atmospheric Data, Power Output Goals)

This algorithm uses a machine learning model to determine the new settings for turbine Tᵢ, considering the current wake interactions, atmospheric data, and desired power output levels.

### Real-Time Adaptive Control

Dynamic Feedback Loop—We create a feedback loop where the turbine's operational data are continuously monitored and fed back into the control system. This system dynamically adjusts turbine settings to optimize performance under changing conditions.
Adjust (Tᵢ) in real-time based on ongoing performance data and W_{ij,new}

This approach continuously adapts the settings of turbine Tᵢ based on performance feedback and updated wake interaction weights.

Integration with Predictive Maintenance

Predictive Analytics for Maintenance—We use data analytics to predict maintenance needs based on operational patterns, wake stress, and historical maintenance data and schedule maintenance activities proactively to minimize downtime and extend turbine lifespan. This model predicts maintenance schedules for turbine Tᵢ based on operational data and wake-induced stress analysis.
Maintenance Schedule_{Ti}:=Predictive Model(Operational Data, Wake Stress Data)

### Step 5: Real-Time Visualization and Monitoring

In this step we develop a real-time visualization and monitoring system for the wind farm that displays the current wake interactions, turbine operational status, and overall efficiency of the wind farm.

### Visualization Dashboard

Dashboard Design—We create a user-friendly interface that displays a real-time graphical representation of the wind farm, including turbine positions, directional wind flow, and wake interactions.

Wake Interaction Visualization—We visualize wake effects dynamically, showing how wakes from each turbine impact others, with color coding or other visual cues to indicate the intensity of the effect.

Integration with Real-Time Data

Data Streaming—We implement a system to stream real-time data from the wind farm's sensors, including wind speed, wind direction, and turbine operational data.

Dynamic Update Mechanism—In this substep, we ensure the dashboard updates in real-time as data streams in, providing up-to-the-minute information on the wind farm's status.

### Performance Metrics and Analytics

Key Metrics Display—Show key performance indicators such as total energy output, turbine efficiency, and wake loss metrics.

Analytical Tools—Include tools for analyzing historical data trends, comparing different operational strategies, and predicting future performance based on current trends.

### Alert and Notification System

Automated Alerts: —We set up an alert system that notifies operators of critical conditions, such as high wake losses, maintenance needs, or operational anomalies.

### Visualization and Data Integration

A comprehensive back-end system that gathers, processes, and feeds data into the visualization dashboard is utilized. Advantageously, it ensures that the system and method is scalable and can handle data from large wind farms with numerous turbines.

By implementing Real-Time Visualization and Monitoring, the windfarm operators and managers will have a powerful tool for real-time monitoring and decision-making. The visualization and monitoring system will aid in understanding the complex dynamics of the wind farm, allowing for proactive management and optimization of its performance.

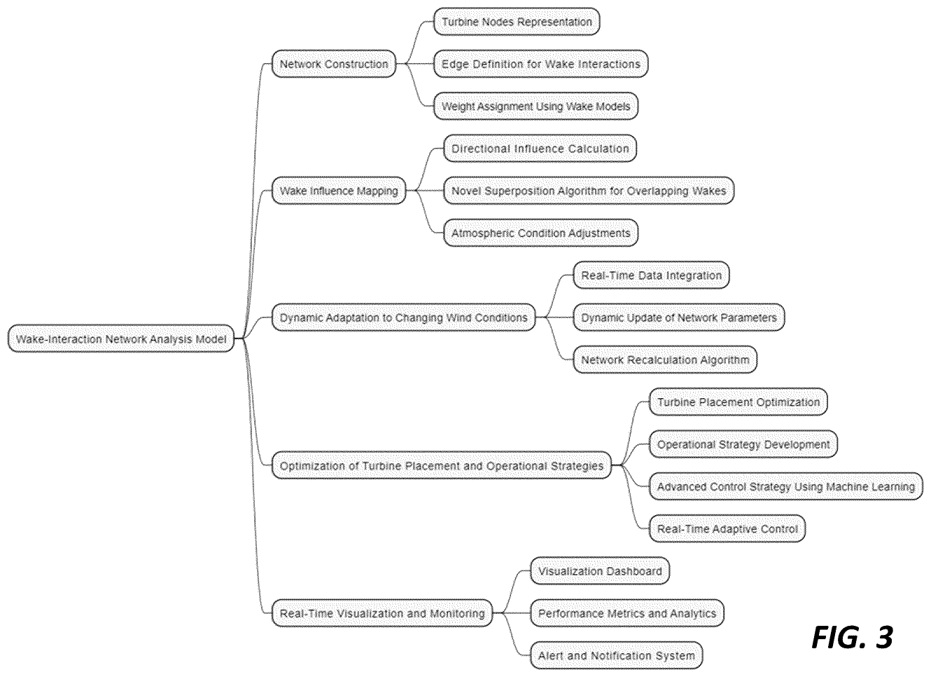

FIG. 3 is a schematic diagram showing illustrative architecture features and relationships or sequences of operation of systems and methods according to aspects of the present disclosure.

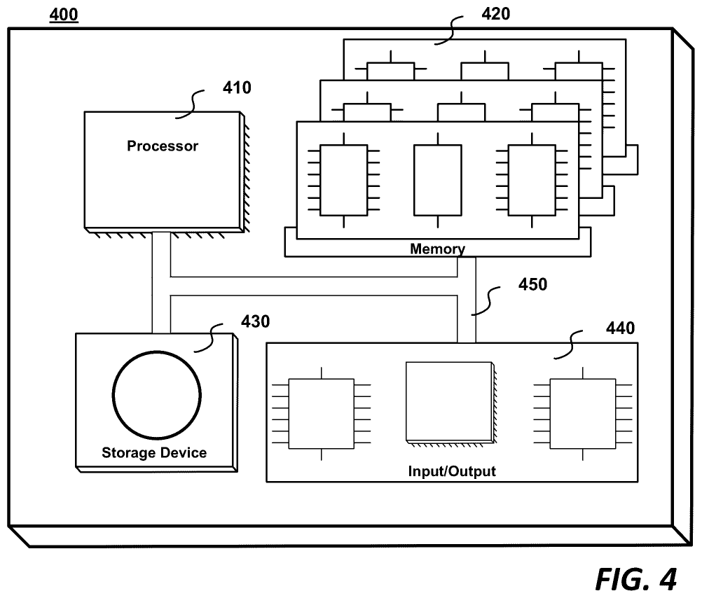

FIG. 4 is a schematic block diagram of an illustrative computing system that may be programmed with instructions that when executed produce the methods/algorithms according to aspects of the present invention.

As may be immediately appreciated, such a computer system may be integrated into another system such as a router and may be implemented via discrete elements or one or more integrated components. The computer system may comprise, for example, a computer running any of a number of operating systems. The above-described methods of the present disclosure may be implemented on the computer system 400 as stored program control instructions.

Computer system 400 includes processor 410, memory 420, storage device 430, and input/output structure 440. One or more input/output devices may include a display 445. One or more busses 450 typically interconnect the components, 410, 420, 430, and 440. Processor 410 may be a single or multi core. Additionally, the system may include accelerators etc., further comprising the system on a chip.

Processor 410 executes instructions in which embodiments of the present disclosure may comprise steps described in one or more of the Drawing figures. Such instructions may be stored in memory 420 or storage device 430. Data and/or information may be received and output using one or more input/output devices.

Memory 420 may store data and may be a computer-readable medium, such as volatile or non-volatile memory. Storage device 430 may provide storage for system 400 including for example, the previously described methods. In various aspects, storage device 430 may be a flash memory device, a disk drive, an optical disk device, or a tape device employing magnetic, optical, or other recording technologies.

Input/output structures 440 may provide input/output operations for system 400.

As those skilled in the art will readily appreciate, benefits of our inventive systems and methods and interactive processes include at least the following.

While we have presented our inventive concepts and description using specific examples, our invention is not so limited. Accordingly, the scope of our invention should be considered in view of the following claims.

1. A computer-implemented method for managing wake interactions in a wind farm, the method comprising:
by the computer:
generating a representation of the wind farm as a network where network nodes represent turbines and network edges represent wake interactions;
mapping each turbine's wake effects on other turbines within the wind farm;
adapting and recalibrating, in real-time, a dynamic wake interaction network model in response to changing wind direction and atmospheric conditions;
utilizing the dynamic wake interaction network model, generate an operational strategy for overall energy production which achieves a pre-determined wake effect; and
generates a real-time visualization and monitoring display for the wind farm that displays current wake interactions, turbine operational status, and measure of overall efficiency of the wind farm.

2. The method of claim 1 wherein each turbine in the wind farm is represented as a node Tᵢ in the generated network, where i is the index of the turbine and a directed edge from turbine node Tᵢ to turbine node Tⱼ represents the wake effect of turbine i on turbine j.

3. The method of claim 2 further comprising assigning weights to network edges based on a wake effect model in which a weight wᵢⱼ on an edge from Tᵢ to Tⱼ represents the impact of turbine i′s wake on turbine j, calculated using a velocity deficit.

4. The method of claim 3 wherein the weight is calculated using the following model equation for velocity deficit
$${w}_{i j} = {V}_{∞} ( 1 - \sqrt{1 - {C}_{T , i}} ) {( \frac{{D}_{i}}{{D}_{i} + 2 α {x}_{i j}} )}^{2}$$
where V_{∞} is the free-stream wind speed, C_{T,i} is the thrust coefficient, Dᵢ is the diameter of the i th turbine rotor, a is the wake decay constant, and xᵢⱼ is the distance from turbine i to turbine j.

5. The method of claim 4 further comprising adjusting any wake effect determinations such that they account for variability in wind direction wherein an impact of a wake on a downstream turbine changes based on relative alignment of a turbine to wind direction.

6. The method of claim 5 further comprising developing a function f(θ) that scales the wake effect based on a relative angle between the wind direction and the turbine alignment such as
$$f ( θ ) = {cos}^{2} ( θ - {θ}_{t u r b i n e} )$$
where ϑ is the wind direction, and θ_{turbine} is the orientation of the turbine axis, and the cosine squared term provides that the wake effect is strongest when the wind direction aligns with the turbine axis and decreases as wind direction angle increases.

7. The method of claim 6 further comprising modeling a combined effect of the wakes from multiple upstream turbines overlap and affect a single downstream turbine.

8. The method of claim 7 wherein the combined effect modeling considers a probability of wake effects combining non-linearly and accounts for a stochastic nature of wake overlap according to the following:
$${V}_{def , combined} = 1 - {\prod }_{k} ( 1 - {V}_{def , k} )$$
where V_{def,k} represents the normalized velocity deficit from each overlapping wake.

9. The method of claim 8 further comprising modifying wake effect determinations to consider atmospheric variability including factors selected from the group consisting of atmospheric stability, humidity, and temperature, which may influence wake behavior according to the following function:
$$g ( Atmospheric Conditions ) = 1 + β \cdot Atmospheric Factor$$
where g (Atmospheric Conditions) adjusts the velocity deficit based on current atmospheric conditions, β is a scaling factor determined empirically by regression analysis or through machine learning algorithms including neural networks, and Atmospheric Factor is a composite measure derived from atmospheric stability, humidity, and temperature such that the function amplifies or reduces the wake effect based on the atmospheric conditions.

10. The method of claim 9 further comprising using real-time meteorological data to continuously update the model with current wind speed (V_{∞}) and direction (ϑ) and updating the weights of all edges in the network based on new wind conditions such that for each edge (Tᵢ→Tⱼ) in the network:
$${w}_{i j , n e w} = {V}_{∞ , n e w} ( 1 - \sqrt{1 - {C}_{T , i}} ) {( \frac{{D}_{i}}{{D}_{i} + 2 α {x}_{i j}} )}^{2} \cdot f ( {θ}_{n e w} )$$
where V_{∞,new} and ϑ_{new} are updated wind speed and direction f(ϑ_{new}) is a function accounting for directional influence, recalculated with new wind direction.
